(19) United States
(12) Patent Application Publication
(10) Pub. No.: US 2008/0226144 A1
(43) Pub. Date: Sep. 18, 2008

(54) DIGITAL VIDEO IMAGING SYSTEM FOR PLASTIC AND COSMETIC SURGERY

(75) Inventors: John R. Squilla, Rochester, NY (US); Daniel P. Schaertel, Webster, NY (US); Steven T. Russell, Spencerport, NY (US); Ralph P. Pennino, Victor, NY (US); Richard A. Simon, Rochester, NY (US)

Correspondence Address: Patent Legal Staff;Carestream Health, Inc., 150 Verona Street, Rochester, NY, 14608, US

(73) Assignee: Carestream Health, Inc.

(21) Appl. No.: 11/954,430

(22) Filed: Dec. 12, 2007

Related U.S. Application Data
(63) Continuation-in-part of application No. 11/687,127, filed on Mar. 16, 2007.

(51) Int. Cl. G06K 9/00

(52) U.S. Cl. 382/128

(57) ABSTRACT

A system for plastic surgery comprises entering patient information into a database; computing a video sequence template for the patient based on the information and a synthetic video model.

### CROSS REFERENCE TO RELATED APPLICATIONS

Reference is made to commonly-assigned copending U.S. patent applications Ser. Nos. 11/555,313, filed Nov. 1, 2006, entitled AUTOMATED CUSTOM REPORT GENERATION SYSTEM FOR MEDICAL INFORMATION, by Squilla et al.; and 11/687,127, filed Mar. 16, 2007, entitled DIGITAL SYSTEM FOR PLASTIC AND COSMETIC SYSTEM, by Squilla et al., the disclosures of which are incorporated herein.

### FIELD OF THE INVENTION

The field of this invention is the area of medical work flow and information systems, specifically those useful for plastic surgeons, dermatologists, and other physicians performing cosmetic procedures or other specialties that use photographic images as an integral part of their practices (hereinafter referred to collectively, with their staff members, as “clinicians”).

### BACKGROUND OF THE INVENTION

As a matter of routine, such clinicians take photographs of their patients for patient photographic documentation. This documentation includes: before and after photographs to show results, to share with colleagues, and to prepare for the surgeries they are going to undertake. Plastic surgery residents often photograph most of their patients for educational purposes.

A guide on what photographs should be considered and how to take them has been published jointly by the American Society of Plastic Surgeons and The Plastic Surgery Educational Foundation and is entitled “Photographic Standards in Plastic Surgery.” The guide includes a series of 12 photographic “templates” for different parts of the body and not only suggests what photographs to take, but how they should be taken in terms of distance and framing. The templates of the guide show a single female model in a suggested number of poses for actual photographs to be taken of a patient. As one can imagine, at times, a clinician may desire a different pose or other photographs. The templates of the guide may be scanned to provide a guide to digital versions.

Even using digital photography, matching the digital photographs to a set of suggested templates is tedious and time consuming. Often, application packages for digital editing (like PhotoShop from Adobe) have been used to try and match the photographs taken to the suggested templates in the guide. In addition, the standard problems of digital photography present themselves as well. These include downloading of the images from which photographs may be printed, getting consistent color (especially from different cameras or different conditions) and photos taken at different times (for the before and after photos or subsequent surgeries, for example). Additionally, measurements on the photograph may need to be taken. Storing the images (often in multiple locations and with specific image formats like DICOM) needs to be supported. Also, collaboration with other clinicians for sharing of information is left to the user as a task that is handled outside of the image manipulations.

Clinicians collect information about the patient as a matter of routine. This information is rarely attached to the images and not often utilized for actions utilizing the images. The workflow that is utilized by the clinicians would be greatly improved by optimizing the process of taking, manipulating, storing and sharing the images in a single application software product or article of manufacture. Some prior art application software has included templates that do not have facial images in them as part of the template. By providing a simple means to add facial images to the process, one can easily see how errors can be reduced.

Prior art in this area includes both analog (non-digital) examples and those that have utilized aspects of digital photography. An example of the color discrepancies that can occur is shown in the Niamtu Imaging Systems website (see URL below) or in cosmetic surgery texts such as “Surgical Rejuvenation of the Face” by Thomas J Baker, MD and Howard L Gordon, MD (C. V. Cosby Co., 1986) and “Cosmetic Dermatolologic Surgery” Leonard M. Dzubow, MD (Lippencott/Raven, 1998). Software for digital cameras, like EasyShare software from Eastman Kodak Company (Kodak), allows for images to be downloaded from the cameras relatively simply and stored logically, for example, by date. Kodak's EasyShare Gallery allows images to be uploaded and shared with others, although downloading of full resolution images by others is not allowed.

Templates are used in many software applications, including Professional Photographers and PictureIt from Microsoft Corporation (Microsoft). These applications allow for the sizing of images to suit the individual. Automated sizing of multiple photos on a page and optimizing the size of the individual images on that page are shown by commonly-assigned copending U.S. patent application Ser. No. 09/559,478, filed Apr. 27, 2000, entitled Method of Organizing Digital Images on a Page, by Richard A. Simon. Algorithms that find faces within a photograph and recognize objects within photographs are well known in the art, especially in consumer and professional photography applications and, more recently, in the Homeland Security area. Synthetic digital models of humans can be created using software packages such as Poser from e-frontier (www.e-frontier.com).

The workflow that a clinician follows can vary from one person to another, whether it is their standard practice, what their comforts and preferences are, or simply different persons performing different functions within the same office. For this reason, the handling of the workflows in an application package of this nature needs to be flexible enough to handle such variations.

Canfield (www.canfieldsci.com) is a provider of camera systems and software for clinicians. Their products range from cameras to camera systems to software specifically designed to take and analyze images for these specialties. Canfield's products do not, however, assess and optimize the workflow of these clinicians nor are they particularly easy to use. They are relatively complicated cameras and do not address issues such as automated download and storage within the clinician's system, adding the images to a customized template, or any of the template features offered in the present invention. There is a direct analogy to consumer digital cameras, there is software to support the camera, but the bulk of what happens after the download is left to the user to handle. Canfield solutions are expensive and require specialized equipment in an effort to make images reproducible. The present invention requires no specialized equipment.

Color targets (for color consistency and color management) are well known in the art. Examples of companies that provide color targets for this purpose are MacBeth and Kodak. Photogrammetry (the ability to make measurements from photographs) is also a well known science. The American Society of Photogrammetry and Remote Sensing, Manual of Photogrammetry, 5th edition, 2004 (Chris McGlone—Editor, Published by ASPRS) shows how this is done.

In U.S. Patent Application Publication No. 2002/0092534 A1 (Shamoun) a networked system is disclosed for previewing potential effects of cosmetic surgery procedures. The present invention does not predict effect, but concentrates on the workflow aspects of the steps prior to the surgery without any prediction of outcome. While the present invention shows past results of other patients, no effect of the current patient is provided.

Similarly, U.S. Patent Application Publication Nos. 2002/0009214 A1 (Arima), 2002/0064302 A1 (Massengill), and 2005/0203495 A1 (Malak) refer to procedural methods of assisting with the surgery rather than improving the workflow of the steps before the surgery or showing pre-surgical information within the operating room (OR), without any predictive outcome methods as shown in these applications.

There are several offerings in the area of cosmetic and plastic reconstructive surgery that mention photographic images and systems within their offerings. These can be found on the Internet and examples include:
http://www.beautysurg.com/see/digital.html
http://www.plasticsurgeryimaging.com/
http://www.angelslab.com/
http://www.profectmedical.com/
http://www.niamtuimaging.com/
http://www.medicalmodeling.com/flashsite/splash.html

Each of these sites either provides a service to make a “before and after” photograph or attempts to predict the results of a surgery on an individual. There is nothing about the improvement of the workflow within a clinician's office or the way the images are taken, edited, stored and/or shared for collaborative purposes. One such site, Profect Medical Systems, offers a photographic system, much like the Canfield offering, but does not assist in the management, manipulation or other aspects mentioned in the present invention. Niamtu Imaging Systems does offer image editing, but only for “before and after” images to attempt to make them look the same in terms of size and lighting. They only attempt to match the original image of the patient to one taken later and make no attempt to match this automatically, only to use standard image editing tools to do this (resize, adjust contrast, brightness, etc.).

The present invention creates a synthetic video model that is used to produce a video sequence template. In turn, the video sequence template is used to assist in taking the proper video sequence of a patient for many different purposes, not just “before and after” photos. Such purposes include: photographs taken for use in surgery, teaching purposes, documentation, multiple procedures, training aids, and assistance in allowing non-clinical personnel to take and edit a video sequence in accordance to pre-determined needs.

Medical Modeling is a site that allows models to be created for use in medical applications. This site can be used as a source of the models used in the present invention in the same way Poser from e-frontier can be used. It does not, however, offer the workflow or the automation of that workflow seen in the present invention, nor does it provide for customized templates showing the photos that are to be taken for the purposes stated above.

### SUMMARY OF THE INVENTION

A method according to the invention or an article of manufacture including software for performing such a method is particularly suitable for clinicians to produce video images of patients for use in cosmetic procedures As such, the method comprises steps or the article comprises steps digitally recorded on a suitable medium, comprising: a) providing a computer data base; b) entering individual patient information into the database, including biometric data and information regarding a proposed cosmetic procedure; c) computing a synthetic video model to produce a video sequence template for the patient in response to the patient information; d) displaying the video sequence template to the patient; e) allowing the patient to perform motions as shown by the video sequence template; f) capturing video images of the motions of the patient; and g) storing the captured video images in the data base.

The present invention allows for a camera agnostic methodology for clinicians to easily bring digital video sequences into an application specifically designed to optimize their workflow, minimize the manipulation of images, allow for data to be added to the images, advanced storage and retrieval capabilities, and allow for automated collaboration and usage in other applications.

The invention comprises a software application with optional storage features and utilizes customizable menus and preferences on data, searching and modifying templates for images. Preferably, instead of using a human model to create a video sequence, a synthetic video model is created and then used to produce a video sequence template. The video sequence template used is determined by the data for the particular patient. This data entry is part of the application. Alternatively, a video sequence template in accordance with the invention may be produced by digitally modifying a video sequence of an actual human model, to create a type of synthetic video model.

### BRIEF DESCRIPTION OF THE DRAWINGS

FIG. 1a is a flowchart of typical workflow for clinicians.

FIG. 1b shows a portion of a graphical user interface in accordance with the invention, including features for modification of the default workflow.

FIG. 2a is an example of a color/measurement target.

FIG. 2b illustrates how measurements can be taken with the target in the photograph.

FIG. 3 shows a sample prior art template and cells within a template.

FIG. 4 shows a sample sign on screen suitable for use in software in accordance with the invention.

FIG. 5 shows a workflow and patient information screen configured in accordance with the invention.

FIGS. 6a and 6b show a template including both the cells of FIG. 3 and sample synthetic models.

FIG. 7 shows an information screen with “before and after” images from an associated database.

FIGS. 8a and 8b show template modification screens including synthetic models.

FIG. 9 shows template/photo implementation screen including synthetic models.

FIGS. 10a and 10b show sample export screens.

FIG. 11 shows a flowchart for using video sequence templates in accordance with the invention.

FIG. 12 shows an example of using a series of still images instead of a video sequence.

### DETAILED DESCRIPTION OF THE INVENTION

The present invention has specific uses in cosmetic and plastic surgery but can be used in other specialties where photographs and/or videos are an integral part of the data collection process. These include dermatology, dentistry, and others. The invention combines aspects of separate systems, allows for customization of the workflow within an office (even to different clinicians within an office), allows for manual tasks to be done automatically and combines image and patient data with multiple storage options and sharing capabilities. For the purpose of the present invention, workflow is defined as “A process description of how tasks are done, by whom, in what order and how quickly. Workflow can be used in the context of electronic systems or people, i.e., an electronic workflow system can help automate a physician's personal workflow.” The source of this definition is “Healthcare Informatics Online” and the URL is: http://www.theebusinesssite.com/IT%20Terms/Health%20Terms.htm#sectW.

In order to understand the present invention, one needs to understand the workflow in a typical clinician's office. In this scenario, the clinician can be the doctor, nurse, or a trained assistant. In fact, it may be a different person at specific steps.

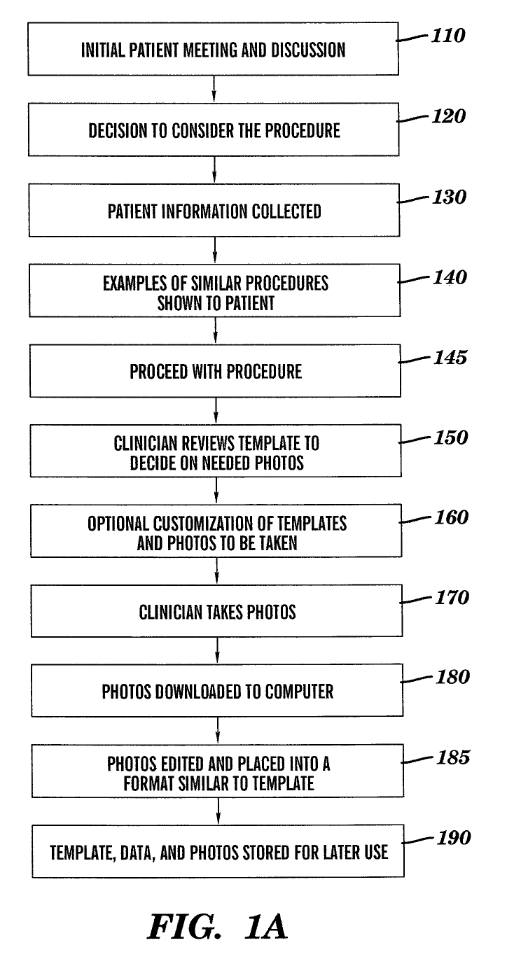

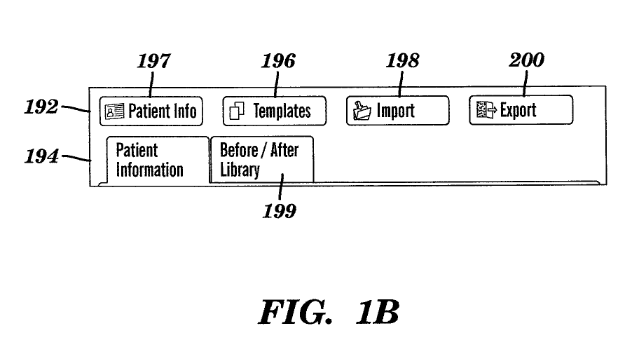

FIG. 1a is a flowchart that shows an example of a typical, prior art pre-surgical workflow for a plastic surgeon. The first step 110 is a meeting between the patient and the clinician(s) to discuss the patient's problem and talk about the procedural alternatives that are to be considered. In the second step 120, it is decided (by both the patient and clinician) that there is something to be done for the patient. In the third step 130, information about the patient that is pertinent to the case is collected. Then in a fourth step 140, samples of previous procedures, often called “before and after” photographs, are shown to the patient so he or she can get an idea of the results that may be seen in his or her case. In a fifth step 145, a decision of performing the procedure has been reached by the patient 145. The clinician then reviews during a sixth step 150 the suggested photographic templates previously described to determine which photographs are to be taken. Certain situations may occur when in a seventh step 160 the clinician wishes to use a special or customized template or photographs that are different than the ones suggested by the photographic templates. In an eighth step 170, photographs are then taken of the patient. In a ninth step 180, the software from the camera is typically used to download the images to a computer (not illustrated). Or a standard interface such as TWAIN may be used to bring them into a specific application. In a tenth step 185, the photographs are then edited in a application program like PhotoShop (see www.adobe.com) or PaintShop Pro (see www.jasc.com). Typically, zooming, cropping, color adjustments and alignment from picture to picture within a template are done manually with this software. Additionally, in an eleventh step 190, the images are then combined into a single image and finally, the images are stored for further use later on.

One can easily see how parts of such a prior art workflow would need to be modified for different clinicians and different patients. For example, one may choose to show the “before and after” images of step 140 before data on the patient is collected in step 130 or one may choose to take the special photographs of step 160 before selecting the suggested photographic template in step 150. Since there are a limited number of the suggested photographic templates, a clinician may become familiar with the pictures that need to be taken and not need to reference the template. The present invention enables these changes in such a workflow by providing a dynamic menuing structure that can be easily modified as shown schematically in FIG. 1b. The illustrated graphical user interface includes general workflow buttons 192 that can be positionally exchanged (in the setup part of the program) by “grabbing” Import button 198 (for example) and moving it ahead of or behind another button, such as Template 196 (for example). This causes the buttons to exchange positions (much as can be done with sheets in Microsoft Excel). In this case, the result is a change in the logical next steps in the application program to match a different, but preferred workflow. In addition, the tabbed areas 194, which represent sub categories of a general workflow step 192, can be changed. In the illustrated example, the tabbed area 199, currently assigned to a particular workflow category (Patient Information button 197, in this case), can be reassigned to a different one such as Templates button 196 or Import button 198. The tabs in those categories would adjust their size, if needed. Similarly, the tabs can be moved in position within a workflow area by dragging them as the buttons were illustrated to be able to be moved previously.

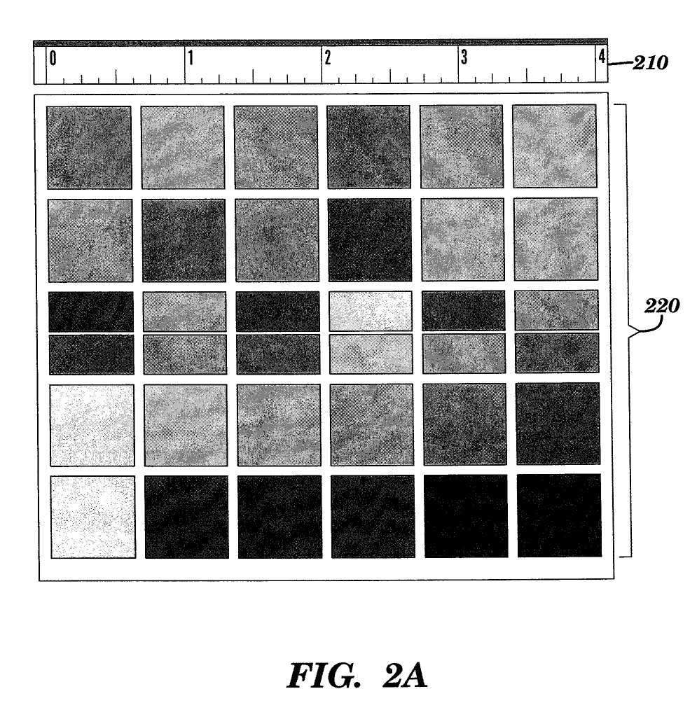

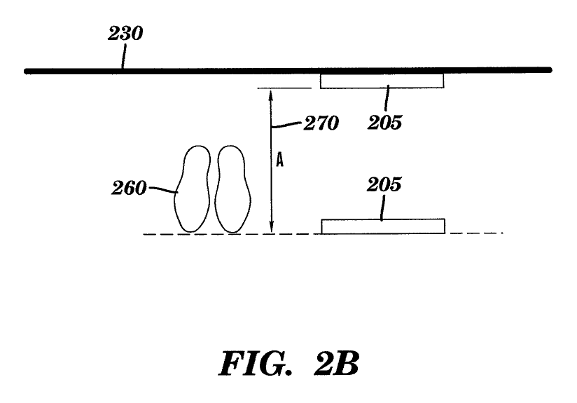

In dealing with photographs, especially those taken at different times and different conditions (lighting, backgrounds, different cameras, etc), it can be difficult to control the color of the images. Color differences can have significant meaning in dealing with medical images and a means to allow consistent color is important to the clinicians. In addition, there are times when it would be desirable to make measurements on the photographs (the science is known as Photogrammetry). FIG. 2a shows a target 205 that can be used in a controlled environment to allow for both consistent color and accurate linear measurements to be taken. The target comprises two parts, a measurement area 210 containing a known linear scale and a color target area 220 containing color patches of known color values (such as a MacBeth color target or Pantone colors, both well known within the professional photography world).

FIG. 2b illustrates how measurements can be obtained from a photograph taken with the target 205 in the photograph. The dimensions in the measurement area 210 are known. Target 205 is placed on a wall 230 or other background area that is fixed. The patient is then placed (via a set of shoeprints 260, for example) a specified distance 270 from the wall 230. Since this distance is known and the distance to patient and the distance to the target are known, linear scaling on the resulting photograph is possible. Alternatively, the target 205 can be placed on the same plane to the camera 250 and the subject 260. The known distances allow the scaling to be done as well. This also means that a movable target can be placed on the same plane as a body part (hand, foot, finger, etc.) and the scaling is accomplished. By placing this target in a known distance from the camera and any part of the subject, the measurement information on the target can be assessed relative to the patient and camera and linear measurements can be made within the resulting photograph. By knowing the camera brand and model, color characteristics can be determined through standard profiles (known in the industry as ICC profiles) for that camera and by comparing the rendered color in the digital image with the standard patches on the target; the image can be corrected for a consistent color rendering. This can be carried through to printers and displays, using the ICC profiles and color management software. The website of the International Color Consortium (ICC) (www.color.org) provides more information on how this is done. This can be done without assistance from the user (other than making sure the target is in the proper location and in the image when taken.)

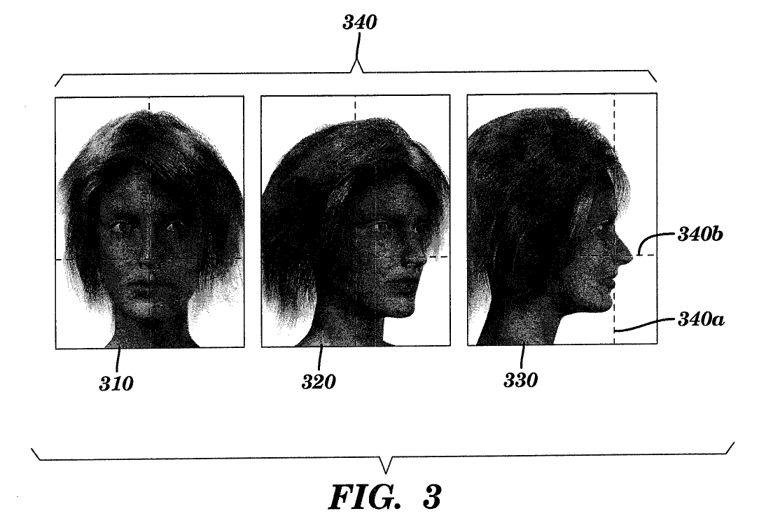

There is a need to define some terms for the present invention. A template is defined as a set of images designed to suggest the photographs to be taken for a procedure on a particular part of the body. FIG. 3 is an example of a set of sample images suggested by the previously mentioned guide. This particular example is for the “Full Face”. The entire template set 340 of images 310, 320, 330 makes up this particular template. The guide suggests as many as six images depending on the part of the body imaged. In fact, a clinician may decide to use more images, fewer images or different images in a particular procedure. If he or she chooses to save such a different set for later use, this is a custom template for that clinician. The individual images 310, 320, 330 also are known as “cells” for the template in the present invention. Dotted alignment lines 340a, 340b preferably are used to make sure that the cells are lined up properly with each other by sizing and/or moving the photographs within the cells using known software techniques such as PhotoShop.

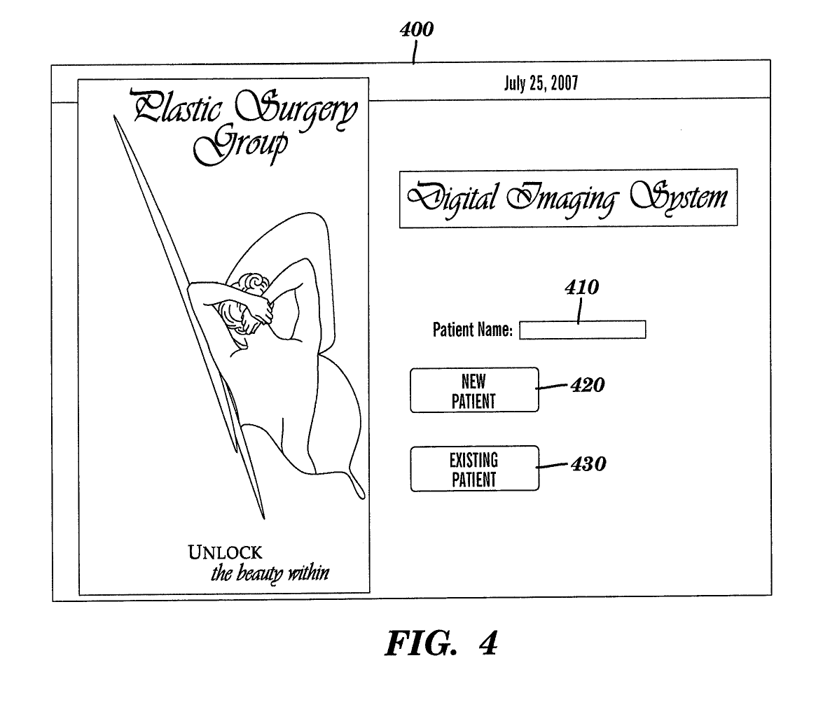

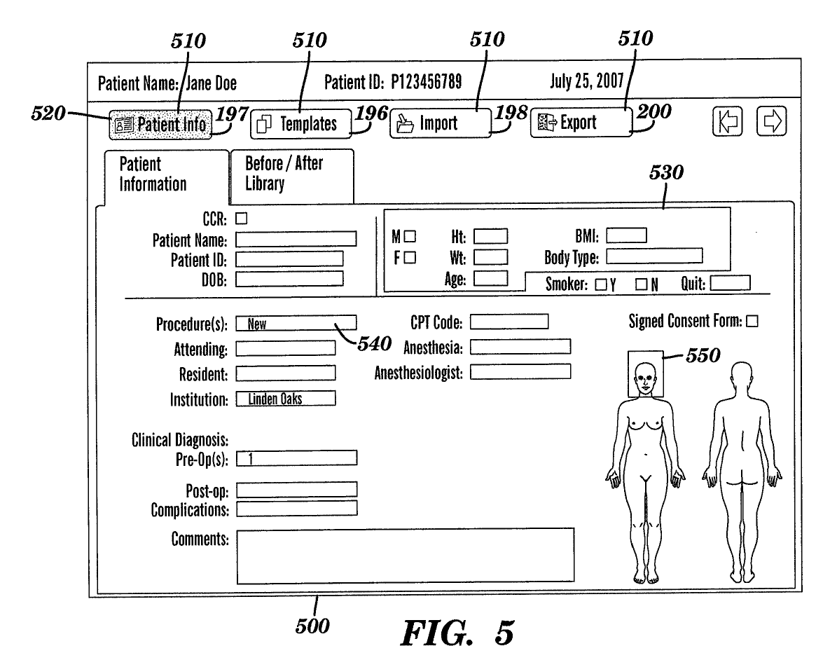

FIG. 4 represents an example of a sign-on screen for an integrated application in accordance with the invention that is specific for plastic surgery preparation. The way in which the workflow was shown in FIG. 1 is translated into the order and logic of the screens in the application. FIG. 4 represents an initial screen 400 for the inventive application. The only input here is a data field 410 for the patient's name which is used to search the clinician's database to determine whether this is an existing patient as shown by indicator 430. If this is the case, information about the patient (shown in FIG. 5) is automatically filled in. If this is a new patient as shown by indicator 420, the data is filled in by the user. The selection of a new or existing patient leads to the data screen shown in FIG. 5.

FIG. 5 shows the patient information input screen 500, according to the invention, but illustrates much more. The top level buttons 510 represent the major components of the workflow as shown in FIG. 1, including a Patient Info button 520 used to call to view the illustrated screen. The tabs 530 (of FIG. 5) represent the rest of the workflow components. These are customizable in the setup area of the program where the top buttons 510 can be moved to match a different workflow, much like menu buttons can be moved in various Microsoft applications using technology available, for example, in the Microsoft developer's toolkit MSDN. The tabs are also changeable and can be moved within a button or moved from button to button. Several pre-determined choices are also provided as standard sets in the setup utility. By allowing the menus and the tabbed areas to be changed, the workflow can be customized (functions modified, changed, added or deleted) to a particular clinician's preferences and allow different functions within the office (clerical, administrative, medical assistant, or trained professionals) to optimize this application to their particular needs.

All of the data fields shown in FIG. 5 are also customizable. Different clinicians and specialties have their own set of informational requirements. The data that is recorded here is able to be added to a patient record 520 (via an HL7 or CCR conversion utility, standard in the medical industry) and is also attached (as metadata to each photograph) to the patient photographs chosen to be used by the clinician. Each photograph will have the same data from this page attached. The data (some or all of it) is also used in different parts of this application for other purposes.

One example is customization of a synthetic human model that is used for overlaying patient photographs. FIG. 3 shows an actual female model used for the suggested photographic template. But, even though such published templates have been recommended by the aforementioned organizations, it can become difficult to match such templates to actual photographs of patients of different race, sex, weights, heights, body types and body mass indexes. Such personal, biometric information for a patient is all part of the standard information gathered by plastic surgeons in preparation for procedures, as well as the type of procedure and the place on the body where the procedure is to be done. This personal data entered in a field 530, the procedure to be considered entered in a field 540 and the body area indicator 550 as illustrated on the homunculus can be used to create a synthetic model much more closely matching that of the patient using known techniques such as disclosed by Poser. The body area indicator 550 is also useful for predetermining the templates that are in consideration for the procedure on the patient.

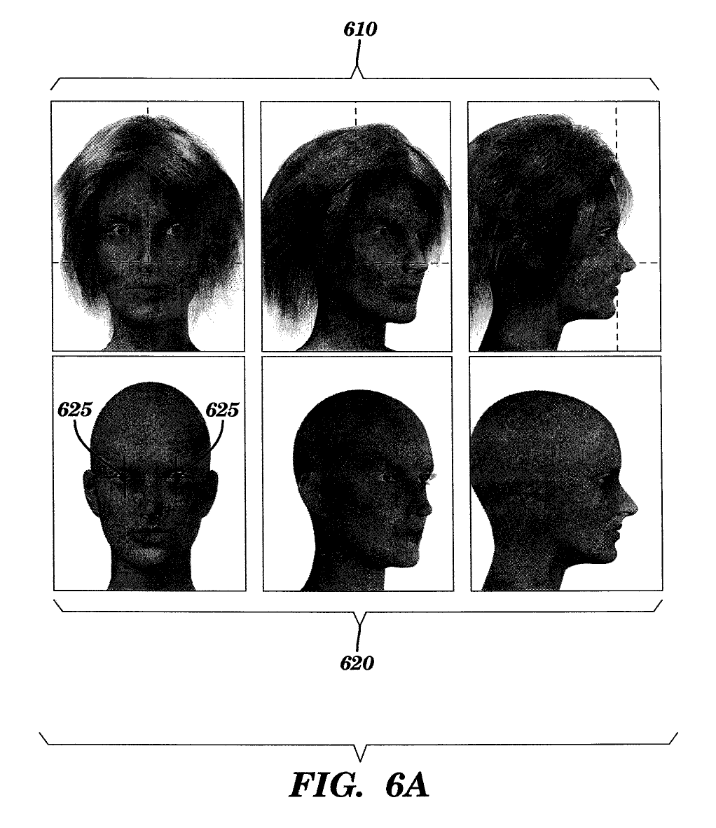

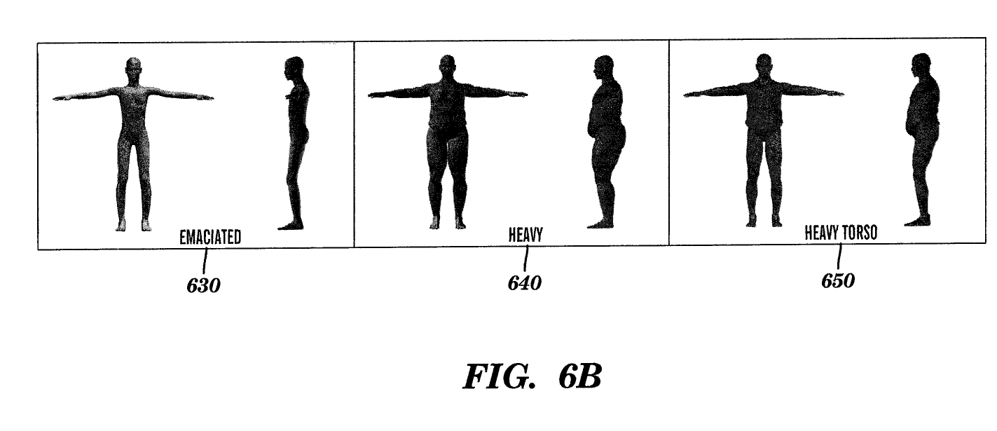

An example of how a synthetic model is advantaged over a human model is illustrated in the case of a very large male patient about to undergo a series of procedures to sculpt his body via liposuction and body sculpting surgeries. It is very cumbersome to try and match the patient images (different height, weight, sex, body type, etc.) to the slender female in the template, as well as set up the alignment lines. A synthetic model of the approximate weight, height and sex of the patient with the same body type would make this very simple. Software such as Poser from e-frontier allows these synthetic models to be generated. This can be done on the fly with the data provided or a set of models can be pre-rendered. Examples of these Poser models are abundant on the Internet. FIG. 6a shows an example of a synthetic model used in lieu of a human one. A template 610 using a human model can be replaced by a template 620 using a synthetic model. Alignment locations 625 are shown on the synthetic model. The application of the current invention allows the user to identify such alignment locations on the patient image using known techniques in software. With this information, the patient images can be sized and matched to the template cell automatically, also using known techniques. It is envisioned that these alignment locations will be provided on each of the template cells.

Note that the synthetic model in template 620 is in its basest form and features such as hair and clothing can easily be added in software applications like the aforementioned Poser software. In this example, patient information like gender, age, weight and body mass index can be used to find a pre-rendered model that most closely approximates the patient. Additionally, the same characteristics can be used to generate a patient specific model directly from the software that generates the model and completely customized to the particular patient. There are other advantages to using a synthetic model over a human one, including the time and cost to employ a human model and licensing and royalty fees that can incur. In addition, the model is separable from the background and is a distinct object that can be scaled, moved or posed within each cell of the template. If desired, the model can even be made to look like the patient by mapping the patient's photograph onto the model, using techniques well-known in the art of photography and 3D-modeling. Software like Poser allows modification of almost every part of the body. Examples shown in FIG. 6b are a synthetic model 630 of a male emaciated body, a synthetic model 640 of a male with a heavy body, and a synthetic model 650 of a body with a heavy torso and normal lower body. These synthetic models can be exported to known 3D packages that would allow further functionality to be implemented. It is also possible with currently known software technology to be able to automatically map photographs of actual patients onto these models. Technology examples include, but are not limited to, face finding so that a patient image automatically can be placed into a template cell of a face; and object recognition technology that can identify a body part (torso, hand, foot, finger, etc) and automatically place patient photographs into these templates. In addition, Poser provides for the models to be edited so that information for a particular patient can be used to provide a reasonable model for each individual.

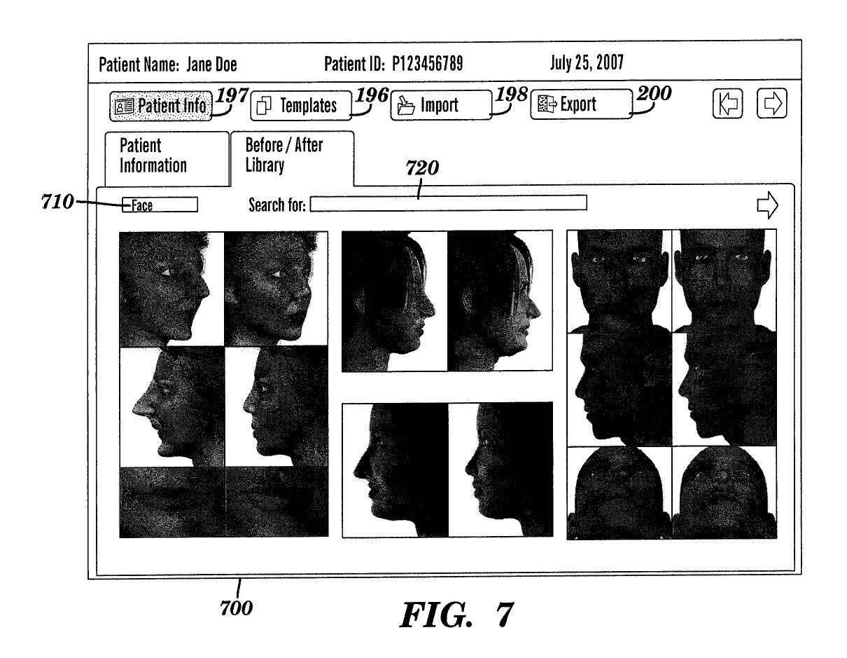

FIG. 7 illustrates a before and after photograph screen 700 to show how the present invention uses information from the data sheet shown in FIG. 5 to assist the clinician's effort in improving the workflow of finding samples of previous work to show a new patient what can be expected. These “before and after” photographs are currently kept in a physical photo album or digitally on a computer. There may even be some information about these in a related database. The present invention differs from such known techniques due to the integrated nature of this function and the ability to interactively label and find specific images of interest. When the procedure to be performed has been entered in a field 540 in FIG. 5, the invention inserts into a body part field 710 an indication of the part of the body of interest and selects the before and after photographs of potential interest to the patient. In addition, the invention may provide the clinician with a search field 720 to further limit the choices. Any information collected on the patient information screen 500 can be used as a search criterion in the search field 720. An typical example of such a searching feature is the Google Desktop, which will search a computer using words an operator may enter. The present invention integrates this functionality and limits it to the data collected as shown in FIG. 5.

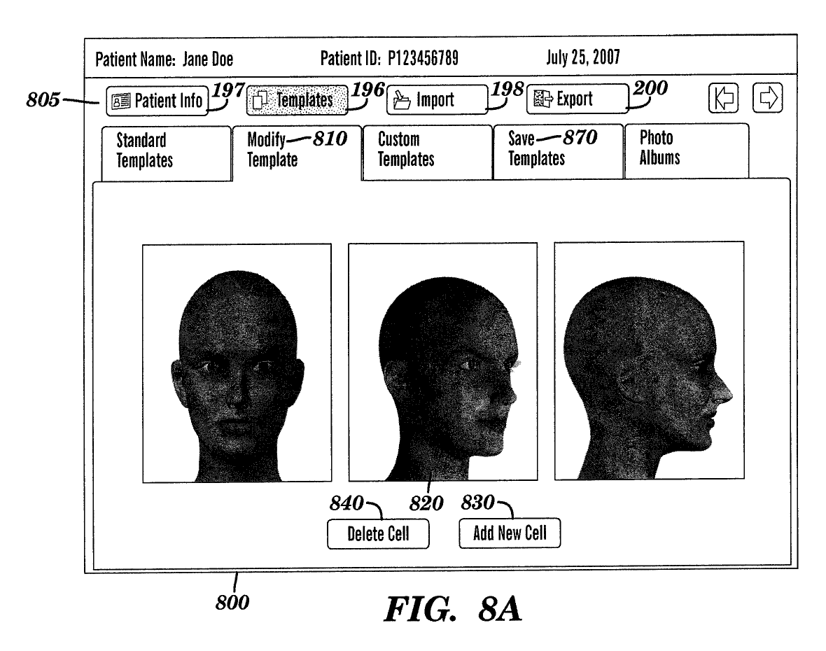

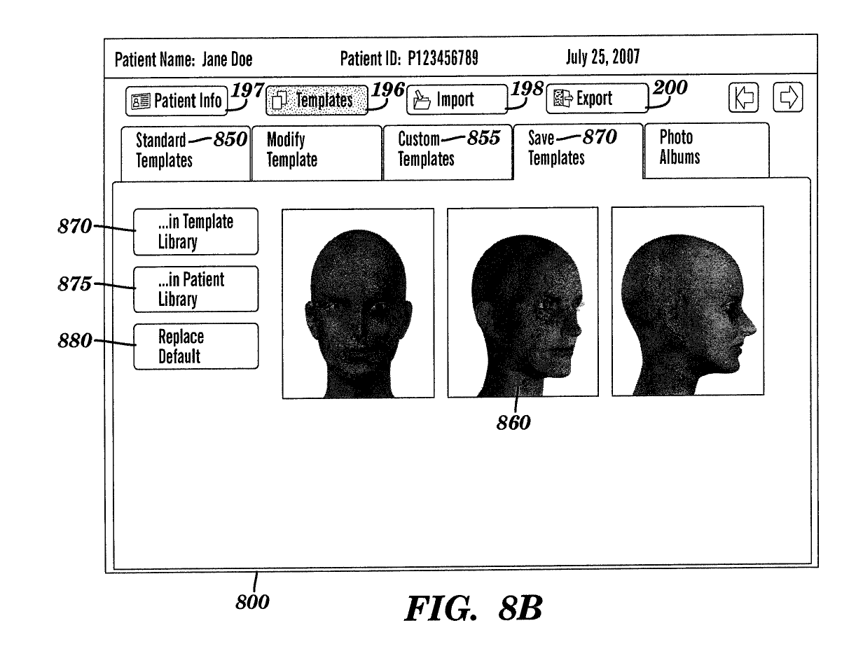

FIGS. 8a and 8b illustrate another workflow improvement over current methodologies. In this case, the clinician is allowed to modify a template for a particular procedure and replace and/or remove any of the cells within a template. Once a template has been chosen, the present invention allows for a modification option shown as a template modification screen 800. Actuation of templates button 196 reveals the screen of FIG. 8a, having a main area 805. A modify template tab 810 has been selected and a cell 820 has been highlighted for modification. Tab 810 includes an add cell button 830 and a delete cell button. If a different number of cells (from the original template) are to be used, the template will automatically resize and realign the cells to optimize placement on the page. This can be done using a means shown in commonly-assigned copending U.S. patent application Ser. No. 09/559,478, filed Apr. 27, 2000, entitled Method of Organizing Digital Images on a Page, by Richard A. Simon. Taking this a step further, a photograph can be taken of a patient and used in several different templates by simply cropping and zooming the photo appropriately. A photograph can be taken of the entire body and be used for the facial templates, mid, and lower body templates by zooming in and cropping the image. With digital cameras routinely having the ability to take 5-20 Mega pixel photos, the resolution is more than enough to make this possible.

In this example of modifying a template, it is desired to remove cell 820 which is a ¾ profile and replace it with a left profile 860 as in FIG. 8b. This replacement cell is chosen from a library of poses and templates by actuating a custom template tab 855 to reveal stored poses and templates pre-rendered for this purpose. If desired, a 3D model can be used and made to move into any position and pose desired. While this may provide more functionality, the time taken to do this could be a productivity problem. In the preferred embodiment, use of such a library is an option, but not the standard means of providing new cells for modification. Once the new template has been created, a save template tab 870 can be actuated to save it for later use using a save in template library button 870, or save it using a save in patient library button 815 for use with a particular patient only, or save it using a replace default template button 880 within the standard template area of a standard template tab 850.

While this functionality works with a human model and taking photos of the model with different pose changes, it is much more cost effective using the synthetic model. Not only will the human model not be required for shots that were not taken (cost and time advantages), but specific model modifications are possible with the synthetic version (hair, facial feature modifications, etc). Specific features of a patient can automatically be detected and applied to the synthetic model directly that would enhance the ease of photo placement. Examples are facial shape, eye parameters, lip and nose size and shape, and many others. Advancements in face-finding algorithms and object recognition make this a reasonable feature, as long as the workflow is not interrupted or extended. This capability enables any body type, and any pose of any part of the body (as well as the entire body). This flexibility greatly enhances the workflow and customization of the processes involved in this type of application. Since software like Poser allows for animations to occur as well, a model can be animated to determine the pose in any particular patient case.

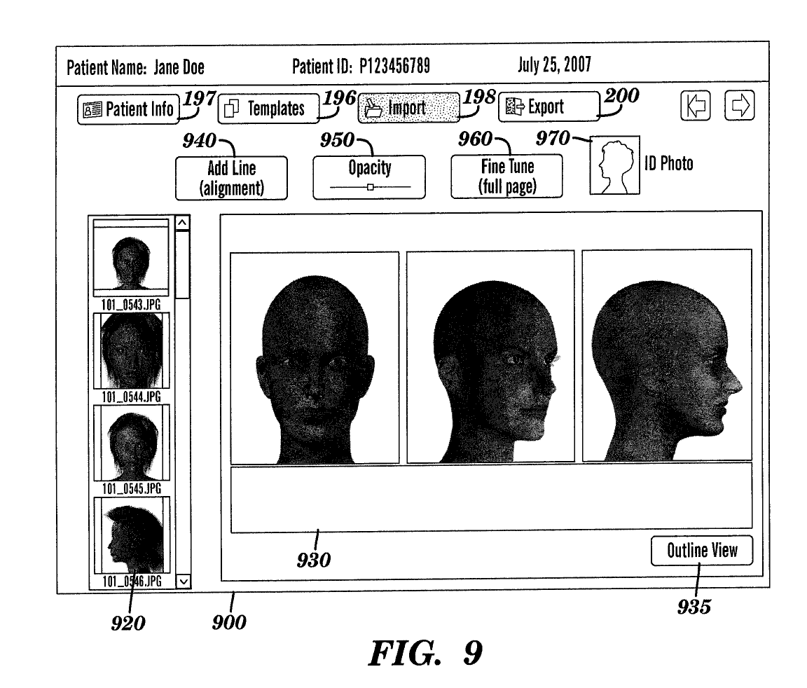

Actuation of import button 198 reveals the import screen 900 of FIG. 9. A plurality of images 920 are selected using standard operating system methods (explorer, “open”, or camera and scan directly into the application using TWAIN or similar methods) and brought together with the chosen template onto screen 900. With known technology, the clinician must use a different, general purpose application to create the template images (PhotoShop, PaintShop Pro). This is a painstaking process that requires skill in the use of these applications and the applications are not set up to perform the specific functions of the present invention. Observations on actual clinical workflow have revealed as much as 30 minutes to perform this task when it can be done in less than a minute with the present invention. The appropriate photograph is chosen from the thumbnails of images 920 and placed into the appropriate cell in the template where the image is aligned and sized to the synthetic model in that cell. This function can be automated where the proper image for the cell is automatically selected (via image analysis looking for a particular pose and features), placed within the proper cell, and sized properly (using face detection and facial feature finding on both the cell model and the patient photo), and placed properly within the cell. All of the technologies mentioned here are well known in the art of professional photography. A comment area 930 may be provided for clinician notes.

Several features are shown to aid in the placement of these images into the cells by the clinician. An outline view button 935 may be included to cause only an outline (not illustrated) of the synthetic model to be seen (as opposed to the fully rendered model). It has been observed that some clinicians find on outline easier than an overlay on a fully rendered model. Another feature of the invention is alignment from photograph to photograph within a template. This is recommended and shown in the published guide “Photographic Standards in Plastic Surgery” as mentioned previously. An add alignment lines button 940 may be included to cause lines to be added across the cells within the template to show alignment to a common feature or features (nose, ears, hips, etc.). Using known technology, the user can add as many of these alignment lines as desired in the X or Y dimension (horizontal and vertical). The model within the cells can also be moved (X and Y) within the cell, as well as the lines themselves, to allow for different type of alignments.

Opacity is the degree of transparency of the template and the photograph so that they can be overlaid and matched. An opacity modification button 950 may be provided as an interactive means to control how opaque the photograph or the template is when matched. A fine tuning button 960 may be provided for fine tuning of the image to the template, a feature especially useful for body extremities. Actuation of button 960 allows any of the cells to be seen full screen and zoomed to a finer level. Opacity and fine detail features are known in products such as PhotoShop.

An additional feature of the current invention is provision to embed ID photograph of the patient into the application. The concept of an ID photograph associated with a patient record is not new. This feature simply allows for embedding an ID photograph at the same time photographs are used for another purpose (placing them into templates). This is another workflow improvement. There is no longer the need to do this as an independent function using another piece of software. The ID photo can be of significant importance in reducing clinical errors. One of the key outputs of the current invention is for use in the operating room as a key to the surgeon as to what needs to be done. Many of the templates do not have the patient's face in them. With this, an actual photograph of the patient is always available to the surgeon as another patient check. In the current invention, a photograph of the patient's face is dragged into the ID photograph icon 970 and kept as part of the template and file. Alternatively, or in addition, a patient identification video sequence can be embedded into the application.

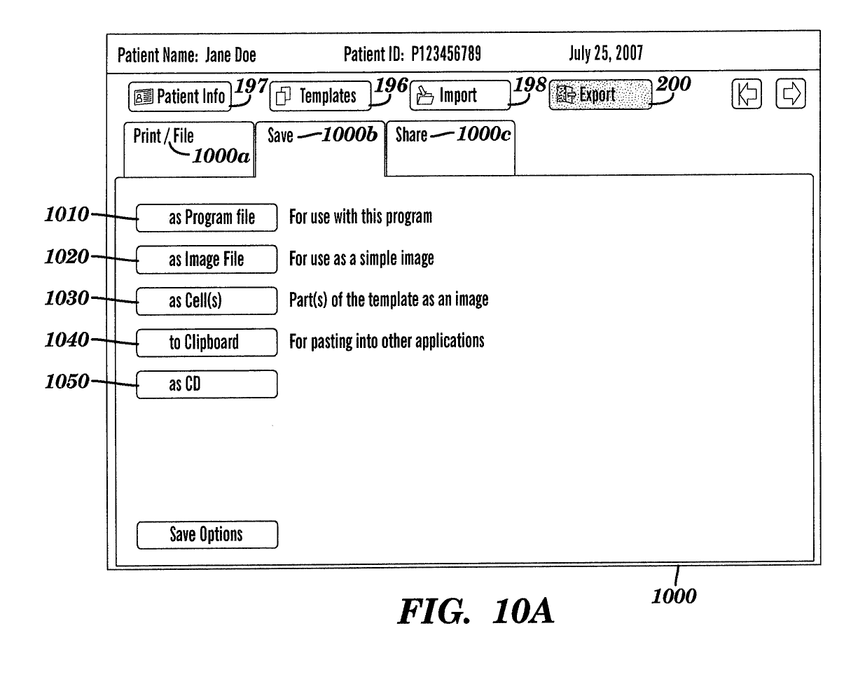

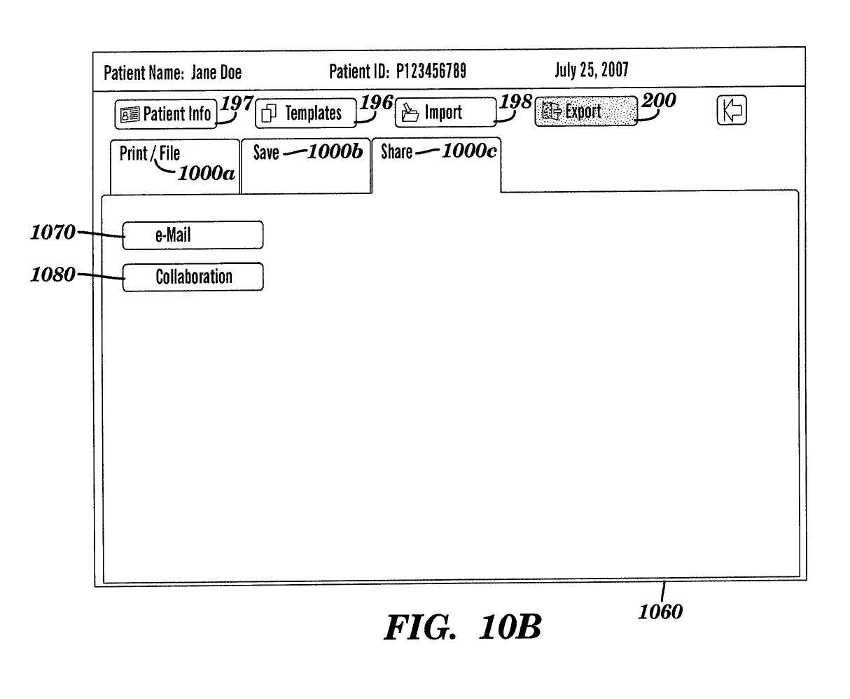

Significant workflow gains can be realized when the effort to construct the templates is completed in accordance with the invention and the clinician proceeds to next steps. There are several ways in which these finalized templates may be used and shared. Actuation of export button 200 reveals the screens of FIGS. 10a and 10b showing the export workflow screen 1000 with option tabs 1000a for print and file, 1000b for save and 1000c for share. Screen 1000 shows the different save formats that are made available and that multiple save options are made available concurrently.

A button 1010 actuates a function of standard save for use within the application for the clinician to stop the work short of completion and continue at a later time. A button 1020 actuates a function of saving the work as an image file to allow for the image to be used in other applications that accept standard image files (JPEG, BMP, etc.). A button 1030 actuates a function to save the individual image cells to allow for a single, or selected multiple images, to be saved in a standard image format. A button 1040 actuates a function for a “clipboard” save, a standard Microsoft Windows feature for quick pasting into other applications. A button 1050 actuates a function to save the entire file (images, metadata, and links to the files) to a CD for use in an off-site area, such as an operating room. Commonly-assigned copending U.S. patent application Ser. No. 11/555,313, filed Nov. 1, 2006, entitled Automated Custom Report Generation System for Medical Information, by Squilla et al. shows an example of such an offsite application where this information can be incorporated. By having a CD (or other portable storage, like a jump drive), the clinician is able to bring the data without the dependency on a network or the Internet. This can be especially useful in secure settings or where computer access is limited. The clinician can also provide his or her own computer, if desired. Each, all, or any combination of these “save” options is selectable. When a choice 1010, 1020, 1030, 1040 or 1050 is made, the selection stays highlighted until it is selected again, when that choice is turned off. The same is true when tab 1000a is actuated for the “share” options as shown in export share screen 1060 in FIG. 10b. In this case, buttons are provided to allow for an e-mail at 1070, collaboration at 1080 or other sharing capabilities (video conferencing, net meetings, etc.). Linking in e-mails is a standard function seen in many Windows applications and technologies such as JPEG and Zoomify allow for high-resolution, high-speed communications of images. As in the “save” menu, these can also be selected at the same time.

In accordance with another embodiment of the invention, a video sequence template can be used by itself or in conjunction with a still image template. Examples are where motion is used to determine flexibility of hands or fingers, how far a patient can bend over, or limited movement of arms or legs. Facial expressions can be videoed to show differences after treatment in a much more effective and efficient manner than utilizing multiple still images. A video sequence of a patient, based on the video sequence template, shows the range of motion and can even indicate a level of discomfort. The major difference in the medical workflow between the video sequence template and the still image template is that the video sequence template is used as a guide for an actual video of the patient; whereas, the still image template is a guide for the medical personnel in taking the photographs.

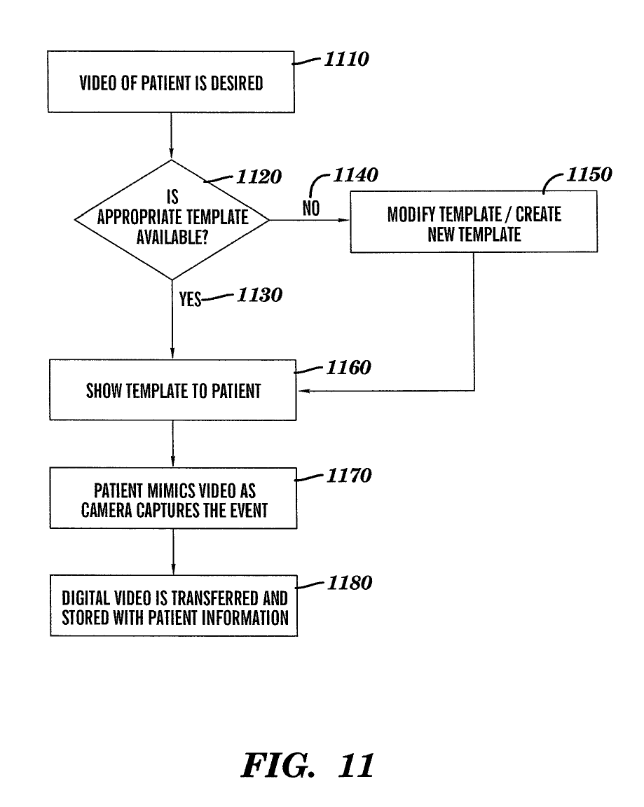

The video sequence template can be activated at the standard template tab 850 shown in FIG. 8b, by including a simple button (not illustrated) to toggle between still image templates and the video sequence template. The video sequence template is defined as a predetermined set of motions to be used as an example for the patient to mimic. The video sequence template preferably is produced using a synthetic video model computed by the same software from which the still image templates are created. Software such as the Poser application has the ability to create movement of the synthetic video model. For this application, the desired movement is pre-determined by the physician and these synthetic video models are placed in the template library. FIG. 11 illustrates the flow for the use of these video sequence templates. The patient's biometric data may be used to adjust the synthetic video model for the patient's unique characteristics to produce the video sequence template for that patient. Poses may be included in the video sequence template that are based on the proposed cosmetic procedures.

FIG. 11 is a flow chart showing the creation and use of video sequence templates in accordance with the invention. It is determined in a first step 1110 whether there is a need for a video of the patient. In a second step 1120, a determination is made whether an appropriate video sequence model or template already is available from the library, an accumulation of pre-rendered videos from an application, videos from the clinician established by his or her experiences, from other clinicians, or some combination of these. If a suitable video sequence model or template is not available at step 1140, one from the library may be modified or a request may be made at step 1150 to have a new template added to the library for future use. As mentioned previously, a synthetic video model may be created and then modified with patient information to produce a video sequence template for the patient. Or, an actual video of a human model can be modified digitally to produce a type of video sequence model. If there is an appropriate video sequence template available at a step 1130 or a new template has been produced or modified at step 1150, the video sequence template is shown to the patent at step 1160 to illustrate to the patient how he or she should move or attempt to move to show range of motion or the effect of the cosmetic surgery. At a step 1170, the patient then mimics the video sequence template as the clinician captures the event on a digital video camera. A digital still camera may be used if a series of still images will suffice. Through known means, the resultant video is then moved in a step 1180 to a computer or other storage for later use with other relevant patient information. The video may be displayed in conjunction with the patient's health record.

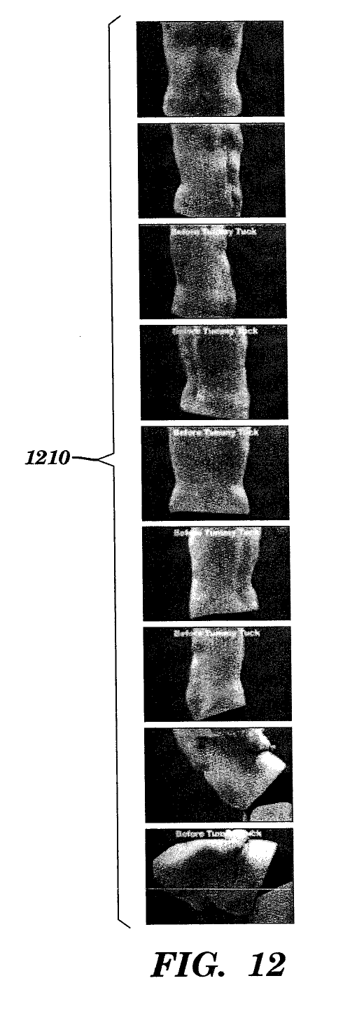

FIG. 12 is an illustration that demonstrates the relative effectiveness of a video versus several stills. A series 1210 of nine stills is shown. A similar video template according to the invention offers dozens of photos at a capture rate of thirty frames per second or more. In addition, a viewer can be prepared using known technology to show before and after videos playable next to each other. Due to the volume of frames, before and after frames of the same positions of the patient can be obtained readily. The clinician can then select any or all of the images or sequences for use in surgery, for explanations to the patient or for demonstrations to other clinicians.

When a video template is shown to a patient, an important illustrative tool is used to enable longitudinal comparisons and before and after surgery comparisons. Having a consistent, repeatable view for the patient to mimic can help in consistency, especially when months may have passed between visits to the clinician. The video template also can be used in surgery to remind the clinician of the existence and magnitude of the problems that exist for the patient, as well as to provide good comparisons for documentation and patient understanding.

These video templates can also be customized by using software such as Poser or via a service specialized to perform this function using such software. Applications, such as Poser, can be used to manipulate a synthetic still model to provide basic body movements that would be required for this medical purpose. As with still image templates, the computer-created synthetic model in the video template can be customized to provide an approximation to the patient characteristics (height, weight, sex, age, body type, etc.).

The invention has been described in detail with particular reference to certain preferred embodiments thereof, but it will be understood that variations and modifications can be effected within the scope of the invention.

### PARTS LIST

110 initial meeting
120 consider procedure
130 patient information collected
140 examples of procedures
145 decision to have procedure
150 review of standard templates
160 customize template
170 photos taken
180 downloading of images
185 photos edited
190 storage of template
192 buttons simulating clinician workflow
194 tabs simulating steps within workflow components
196 templates button
197 patient information button
198 import button
199 tab capable of being moved to different workflow step
200 export button
205 target
210 measurement area
220 color target area
230 wall
250 camera
260 footprints for patient placement
270 distance from patient to target on wall
310 cells within a template
320 cells within a template
330 cells within a template
340 template set
340, 340a dotted alignment lines
400 initial screen
410 name field
420 indicator for new patient
430 indicator for existing patient
500 patient information screen
510 buttons for general workflow
520 patient information button
530 patient personal information field
540 procedure field
550 body area indicator
610 template using human model
620 template using synthetic model
625 alignment locations
630 emaciated synthetic model
640 heavy synthetic model
650 heavy torso synthetic model
700 before and after photographs screen
710 body part field
720 search field
800 template modification screen
805 main screen area
810 modify template tab
820 cell to be modified
830 add cell option button
840 delete cell option button
850 standard template tab
855 custom template tab
860 left profile for modified cell
870 save in template library button
875 save in patient library button
880 replace default button
900 screen for placing images into template
920 selected patient images
930 comment area
935 outline view button
940 add alignment lines button
950 opacity modification button
960 fine tune button
970 icon for placement of ID photo
1000 export workflow screen
1000a tab for print and file option
1000b tab for save option
1000c tab for share option
1010 button for saving as program file
1020 button for saving as image file
1030 button for saving part of template
1040 button for saving to clipboard
1050 button for saving to CD for use elsewhere
1060 export share screen
1070 export to e-mail
1080 collaboration with another clinician
1110 patient video considered
1120 video template library searched
1130 video template available
1140 video template not available
1150 new video template created or modified
1160 patient view of video template
1170 still and/or video imaging of patient
1180 store patient video information
1210 still frames of patient in different poses

1. A method for use by clinicians to produce video images of patients for use in cosmetic procedures, comprising steps of:
a) providing a computer data base;
b) entering individual patient information into the database, including biometric data and information regarding a proposed cosmetic procedure;
c) computing a video sequence template for the patient in response to the patient information;
d) displaying the video sequence template to the patient;
e) allowing the patient to perform motions as shown by the video sequence template;
f) capturing video images of the motions of the patient; and
g) storing the captured video images in the data base.

2. A method according to claim 1, wherein the patient information includes patient personal information.

3. A method according to claim 1, wherein the video sequence template is computed based on the patient's size-, gender- and/or race-based biometric data.

4. A method according to claim 1, wherein the video sequence template includes poses based on the proposed cosmetic procedure.

5. A method according to claim 1, further comprising a step of customizing a workflow for a clinician via a dynamically changeable menuing system.

6. A method according to claim 1, further comprising a step of integrating an identification photograph of the patient into the data base.

7. A method according to claim 1, further comprising a step of integrating a patient identification video into the data base.

8. A method according to claim 1, further comprising a step of integrating a color and measurement target for photographic images.

9. A method according to claim 1, further comprising steps of providing multiple simultaneous save options and sharing options.

10. A method according to claim 1, further comprising a step of providing a utility to automatically view the video sequence template in an electronic health record.

11. An article of manufacture comprising:
a) a medium for digitally recording application software;
b) application software recorded on the medium, the software providing a method for use by clinicians to produce video images of patients for use in cosmetic procedures, the method comprising steps of:
i) providing a computer data base;
ii) entering individual patient information into the database, including biometric data and information regarding a proposed cosmetic procedure;
iii) computing a video sequence template for the patient in response to the patient information;
iv) displaying the video sequence template to the patient;
v) allowing the patient to perform motions as shown by the video sequence template;
vi) capturing video images of the motions of the patient; and
vii) storing the captured video images in the data base.

12. An article of manufacture according to claim 11, wherein the patient information includes patient personal information.

13. An article of manufacture according to claim 11, wherein the video sequence template is computed based on the patient's size-, gender- and/or race-based biometric data.

14. An article of manufacture according to claim 11, wherein the video sequence template includes poses based on the proposed cosmetic procedure.

15. An article of manufacture according to claim 11, further comprising a step of customizing a workflow for a clinician via a dynamically changeable menuing system.

16. An article of manufacture according to claim 11, further comprising a step of integrating an identification photograph of the patient into the data base.

17. An article of manufacture according to claim 11, further comprising a step of integrating an identification video of the patient into the data base.

18. An article of manufacture according to claim 11, further comprising a step of integrating a color and measurement target for photographic images.

19. An article of manufacture according to claim 11, further comprising steps of providing multiple simultaneous save options and sharing options.

20. An article of manufacture according to claim 11, further comprising a step of providing a utility to automatically view the video sequence template in an electronic health record.
